(19) United States
(12) Patent Application Publication
(10) Pub. No.: US 2017/0297186 A1
(43) Pub. Date: Oct. 19, 2017

(54) FASTENER DRIVING TOOL

(71) Applicant: Illinois Tool Works Inc., Glenview, IL (US)

(72) Inventor: Robert J. Meyer, Palatine, IL (US)

(21) Appl. No.: 15/410,258

(22) Filed: Jan. 19, 2017

Related U.S. Application Data
(60) Provisional application No. 62/322,549, filed on Apr. 14, 2016.

(51) Int. Cl. B25C 1/04; B25C 1/00

(52) U.S. Cl. CPC B25C 1/047; B25C 1/008

(57) ABSTRACT

A pneumatic powered fastener driving tool having components configured, weighted, sized, shaped, placed, and arranged such that a first center of gravity envelope that encompasses a first defined area related to a top section of a trigger of the tool for a first operational state, a second center of gravity envelope that encompasses a second defined area related to a bottom section of the trigger of the tool for a second operational state, and a plurality of third center of gravity envelopes that each encompass an area between the first center of gravity envelope and the second center of gravity envelope for third operational states.

### PRIORITY CLAIM

This application claims priority to and the benefit of U.S. Provisional Patent Application Ser. No. 62/322,549, filed Apr. 14, 2016, the entire contents of which are incorporated herein by reference.

### BACKGROUND

Powered fastener driving tools are well known and commercially widely used throughout North America and other parts of the world. Powered fastener driving tools are typically electrically powered, pneumatically powered, combustion powered, or powder-activated. Powered fastener driving tools are typically used to drive fasteners (such as nails, staples, and the like) to connect a first material, item, or workpiece to a second material, item, or workpiece.

Various known powered fastener driving tools include: (a) a housing; (b) a power source or supply assembly in, connected to, or supported by the housing; (c) a fastener supply assembly in, connected to, or supported by the housing; (d) a fastener driving assembly in, connected to, or supported by the housing; (e) a trigger mechanism partially in, connected to, or supported by the housing; and (f) a workpiece contactor or contacting element (sometimes referred to herein as a “WCE”) connected to or supported by the housing. The WCE is configured to engage or contact a workpiece and to operatively work with the trigger mechanism such that the WCE needs to be depressed or moved inwardly a predetermined distance with respect to the housing before activation of the trigger mechanism causes actuation of the powered fastener driving tool.

Powered fastener driving tools typically have two different types of operational modes and one or more mechanisms that enable the operator to optionally select one of the two different types of operational modes that the operator desires to use for driving the fasteners. One operational mode is known in the industry as the sequential or single actuation operational mode. In this operational mode, the depression or actuation of the trigger mechanism will not (by itself) initiate the actuation of the powered fastener driving tool and the driving of a fastener into the workpiece unless the WCE is sufficiently depressed against the workpiece. In other words, to operate the powered fastener driving tool in accordance with the sequential or single actuation operational mode, the WCE must first be depressed against the workpiece followed by the depression or actuation of the trigger mechanism. Another operational mode is known in the industry as the contact actuation operational mode. In this operational mode, the operator can maintain the trigger mechanism at or in its depressed position, and each time the WCE subsequently contacts and is sufficiently pressed against the workpiece the powered fastener driving tool will actuate, thereby driving a fastener into the workpiece.

One known commercially available pneumatic powered fastener driving tool is the PASLODE® PMP or POWERMASTER PLUS® Pneumatic Framing Nailer sold by a division of the assignee of the present application (PASLODE and POWERMASTER PLUS are registered trademarks of Illinois Tool Works Inc.). This known pneumatic powered fastener driving tool is often referred to as a framing nailer or pneumatic nailer and is generally diagrammatically illustrated in FIG. 1. This known pneumatic powered fastener driving tool 10 generally includes: (a) a housing 12 including a main compartment 14 and a handle 16 extending from the main compartment 14; (b) a power source or supply assembly (not shown) in the housing 12; (c) a pneumatic end plug 40 connected to a bottom of the handle 16; (d) a fastener supply assembly 50; (e) a fastener driving assembly (not shown); (f) a trigger mechanism 60; (g) a WCE 70; and (h) a belt hook 80 rotatably connected to the bottom of the handle 16. The handle 16 is integrally formed with the main compartment 14 and is partially covered by a plastic protective cover 29. The pneumatic end plug 40 is sized, shaped, or otherwise configured to receive an outwardly extending pneumatic connector 42 sized, shaped, or otherwise configured to connect to a compressed air supply hose (not shown) that supplies compressed air to this pneumatic powered fastener driving tool 10. The compressed air flows through the pneumatic connector 42 and the pneumatic end plug 40, through the air inlet (not shown) in the handle 16, and through one or more channels (not shown) in the handle 16 to the power source or supply assembly (not shown) in the housing 12 to power the pneumatic powered fastener driving tool 10.

One issue with pneumatic powered fastener driving tools such as the tool 10 arises due to repeated use of the tool by an operator. Many operators use such known commercially available pneumatic powered fastener driving tools throughout the day on a regular or continuous basis as they are working. Many operators hold these tools for substantial parts of the day. Many operators pick up or lift and put down these tools numerous times throughout the day. Depending on the job or project the operator is working on, the operator may pick up and put down the tool dozens to several hundred times a day. Although various pneumatic powered fastener driving tools (such as the PASLODE® PMP or POWERMASTER PLUS® Pneumatic Framing Nailer) typically weigh less than eight and one-half pounds, the continuous use and holding of these tools as well as the repetitive lifting and putting down of these tools tend to cause operator fatigue.

A further issue with pneumatic powered fastener driving tools such as the tool 10 relates to the amount of recoil felt by the operator after the tool drives each fastener. The greater the recoil, the greater the negative effect or fatigue on the operator.

A further issue with pneumatic powered fastener driving tools such as the tool 10 relates to the amount of vibration felt by the operator using the tool. The greater the vibration, the greater the negative effect or fatigue on the operator.

To address or reduce operator fatigue, over the years manufacturers of such tools have: (a) reduced or minimized the size of these tools, (b) reduced or minimized the weight of these tools, (c) made these tools more ergonomic, and (d) reduced or minimized the vibration of the tools in use.

These methods of addressing or reducing operator fatigue using the known tools have made great strides in reducing operator fatigue. However, there is still a continuing need to further reduce operator fatigue associated with pneumatic powered fastener driving tools and particularly framing nailers.

### SUMMARY

Various embodiments of the present disclosure provide a pneumatic powered fastener driving tool and particularly a framing nailer that further reduces operator fatigue by locating the tool's center of gravity in specific optimal envelopes and more specifically at specific optimal locations in those optimal envelopes at one or a plurality of the tool's various different operational states.

In various embodiments, the pneumatic powered fastener driving tool has various components configured, weighted, sized, shaped, placed, and arranged such that a first center of gravity envelope that encompasses a first defined area related to a top section of a trigger of the tool for a first operational state, a second center of gravity envelope that encompasses a second defined area related to a bottom section of the trigger of the tool for a second operational state, and a plurality of third center of gravity envelopes that each encompass an area between the first center of gravity envelope and the second center of gravity envelope for third operational states.

More specifically, the present disclosure recognizes that when trying to determine the optimal locations for the center of gravity of the tool, there are multiple different operational states of the tool that need to be considered and that make these determinations extremely complicated. These different operational states vary based on how many fasteners (if any) are in the fastener supply assembly. These different operational states can also vary based on whether the compressed air supply line is attached to the tool. These factors (along with the configuration, weight, size, shape, placement, and arrangement of the components of the tool) change or affect the center of gravity of the tool for each different operational state.

More specifically, in a first operational state, the fastener supply assembly is completely empty (i.e., it does not include any fasteners) and the compressed air supply line is not connected to the pneumatic connector. In a second operational state, the fastener supply assembly includes a full supply of fasteners (such as a magazine filled with one or more strips of fasteners) and the compressed air supply line is not connected to the pneumatic connector. The tool includes a plurality of third operational states. In each third operational state, the fastener supply assembly includes at least one fastener but less than a full supply of fasteners (i.e., one or more but not all of the fasteners have already been used) and the compressed air supply line is not connected to the pneumatic connector. For purposes of this application, these three states will be primarily discussed.

The tool also includes other operational states in which the fastener supply assembly is completely empty, completely filled, or partially filled, and the compressed air supply line is connected to the pneumatic connector. For purposes of this application, these additional states will not be primarily discussed because the type, size, and weight of the pneumatic hoses (and the forces applied to the tool by the pneumatic hoses) can greatly vary.

In certain embodiments, the first center of gravity envelope (for the first operational state), the second center of gravity envelope (for the second operational state), and the plurality of third center of gravity envelopes (for the third operational states) each encompass an area generally forward and generally rearward of the front face of the trigger of the tool, and are each generally centered along, slightly forward of, or slightly rearward of the front face of the trigger of the tool. In certain such embodiments, the centers of the first, second, and third center of gravity envelopes generally form a line that is parallel to or substantially parallel to and extends along the front face of the trigger of the tool. In other such embodiments, the centers of the first, second, and third center of gravity envelopes generally form a line that is parallel to or substantially parallel to and is offset forward or rearward from the front face of the trigger of the tool.

In certain other embodiments, the first center of gravity envelope (for the first operational state), the second center of gravity envelope (for the second operational state), and the plurality of third center of gravity envelopes (for the third operational states) each encompass an area generally forward of the front face of the trigger of the tool. In certain such embodiments, the centers of the first, second, and third center of gravity envelopes generally form a line that is parallel to or substantially parallel to the front face of the trigger of the tool.

In certain other embodiments, the first center of gravity envelope (for the first operational state), the second center of gravity envelope (for the second operational state), and the plurality of third center of gravity envelopes (for the third operational states) each encompass an area generally rearward of the front face of the trigger of the tool. In certain such embodiments, the centers of the first, second, and third center of gravity envelopes generally form a line that is parallel to or substantially parallel to the front face of the trigger of the tool.

More specifically, in various embodiments of the present disclosure, the pneumatic powered fastener driving tool includes: (a) a housing assembly including a main compartment assembly and a handle assembly extending from the main compartment assembly; (b) an end plug assembly removably attached to the handle assembly; (c) a power source or supply assembly positioned in the housing assembly; (d) a fastener supply assembly connected to the housing assembly; (e) a fastener driving assembly in the housing assembly; (f) a trigger mechanism assembly connected to and extending from the handle assembly of the housing assembly; (g) a work piece contact element assembly connected to the main compartment assembly of the housing assembly; (h) a belt hook assembly movably connected to the end plug assembly; and (i) a pneumatic connector connected to the end plug assembly.

In various embodiments of the present disclosure, these assemblies and components of the pneumatic powered fastener driving tool of the present disclosure are configured, weighted, sized, shaped, placed, and arranged such that the tool's center of gravity in the each of the three different operational states is located within an optimal total center of gravity envelope which encompasses an area forward and rearward of the trigger including portions of the top and bottom sections of the trigger and portions of the front face of the trigger. In various embodiments, the optimal total center of gravity envelope extends parallel to or substantially parallel to the front face of the trigger. This total center of gravity envelope for all of the operational states is referred to herein as the total COG envelope.

In various embodiments of the present disclosure, these assemblies and components of the pneumatic powered fastener driving tool of the present disclosure are configured, weighted, sized, shaped, placed, and arranged such that the tool's center of gravity in the first operational state (in which the fastener supply assembly is empty or does not include any fasteners and the compressed air supply line is not connected to the pneumatic connector) is in a first envelope which encompasses an area generally forward and generally rearward of the top section of the trigger and includes a portion of the front face of the trigger. This center of gravity envelope for the first operational state is referred to herein as the first COG envelope.

In various embodiments of the present disclosure, these assemblies and components of the pneumatic powered fastener driving tool of the present disclosure are configured, weighted, sized, shaped, placed, and arranged such that the tool's center of gravity in the second operational state (in which the fastener supply assembly includes a full supply of fasteners and the compressed air supply line is not connected to the pneumatic connector) is in a second envelope which encompasses an area generally forward and generally rearward of the bottom section of the trigger and includes a portion of the front face of the trigger. This center of gravity envelope for the second operational state is referred to herein as the second COG envelope.

In various embodiments of the present disclosure, these assemblies and components of the pneumatic powered fastener driving tool of the present disclosure are configured, weighted, sized, shaped, placed, and arranged such that, as the tool moves from one of the third operational states to another (in which the fastener supply assembly includes at least one fastener but less than a full supply of fasteners and the compressed air supply line is not connected to the pneumatic connector), the location of the tool's center of gravity repeatedly changes (to a relatively small or minor degree). Specifically, the tool's center of gravity repeatedly moves from (or between) the first center COG envelope to the second COG envelope. The center of gravity envelopes for the third operational states are referred to herein as the third COG envelopes. In various embodiments, each third COG envelope encompasses an area generally forward and generally rearward of the trigger and includes a portion of the front face of the trigger.

It should be appreciated that components of the pneumatic powered fastener driving tool of various embodiments of the present disclosure are configured, weighted, sized, shaped, placed, and arranged such that the tool has all of the first, second, and third COG envelopes when respectively in the first, second, and third operational states.

It should also be appreciated that in other embodiments of the present disclosure, the pneumatic powered fastener driving tool includes one or a plurality but not all of the first, second, and third COG envelopes.

Thus, it should further be appreciated that in various embodiments of the present disclosure, the pneumatic powered fastener driving tool provides center of gravity envelopes that are located relative to one another along optimal defined directions, lines, or planes and at optimal determined distances from or relative to the trigger based on such operational states.

Each of the center of gravity envelopes of the tool of the present disclosure individually reduces the fatigue on the operator by providing a more balanced tool in each of the different respective operational states

The combination of a plurality but less than all of these determined center of gravity envelopes of the tool of the present disclosure reduce the fatigue on the operator by providing a more balanced tool overall for a combination of each of the respective different operational states.

The combination of all of these determined center of gravity envelopes of the tool of the present disclosure reduce the fatigue on the operator by providing a more balanced tool overall for a combination of each of the respective different operational states or the optimal total COG envelope.

It should be appreciated that, regardless of the location of the center of gravity in any operational state, as is well known in the industry, the operator should: (a) only maintain their finger or fingers on the trigger when the tool is actually positioned in a correct position for use or dispensing of the fastener; and (b) not carry or transport the tool from one location to another location with their finger or fingers on the trigger.

Other objects, features, and advantages of the present disclosure will be apparent from the following detailed disclosure, taken in conjunction with the accompanying sheets of drawings, wherein like reference numerals refer to like parts.

### BRIEF DESCRIPTION OF THE FIGURES

FIG. 1 is a fragmentary diagrammatic side perspective view of a known powered fastener driving tool, and specifically a known pneumatic nailer.

FIG. 2 is a rear perspective view of a powered fastener driving tool, and specifically a framing nailer, of one example embodiment of the present disclosure.

FIG. 3 is a front perspective view of the framing nailer of FIG. 2 connected to a compressed air line or hose.

FIG. 4 is a left side view of the framing nailer of FIG. 2.

FIG. 5 is a right side view of the framing nailer of FIG. 2.

FIG. 6 is a top view of the framing nailer of FIG. 2.

FIG. 7 is a bottom view of the framing nailer of FIG. 2.

FIG. 8 is a rear view of the framing nailer of FIG. 2.

FIG. 9 is a front view of the framing nailer of FIG. 2.

FIG. 10 is left side view of the framing nailer of FIG. 2 in the first operational state, and illustrates the center of gravity envelope and one of the center of gravity locations in that envelope when the framing nailer is in the first operational state.

FIG. 11 is left side view of the framing nailer of FIG. 2 in the second operational state, and illustrates the center of gravity envelope and one of the center of gravity locations in that envelope when the framing nailer is in the second operational state.

FIG. 12 is left side view of the framing nailer of FIG. 2 in one of the third operational states, and illustrates the center of gravity envelope and one of the center of gravity locations in that envelope when the framing nailer is in one of the third operational states.

FIG. 13 is left side view of the framing nailer of another embodiment of the present invention in the first operational state, and illustrates the center of gravity envelope and one of the center of gravity locations in that envelope when the framing nailer is in the first operational state.

FIG. 14 is left side view of the framing nailer of FIG. 13 in the second operational state, and illustrates the center of gravity envelope and one of the center of gravity locations in that envelope when the framing nailer is in the second operational state.

FIG. 15 is left side view of the framing nailer of FIG. 13 in one of the third operational states, and illustrates the center of gravity envelope and one of the center of gravity locations in that envelope when the framing nailer is in one of the third operational states.

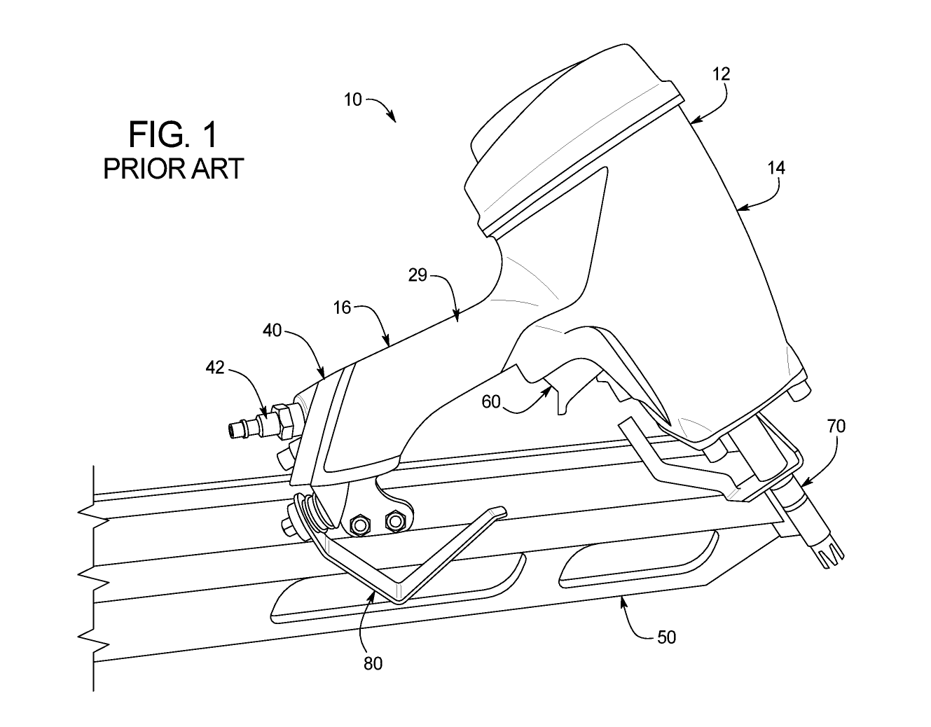

### DETAILED DESCRIPTION

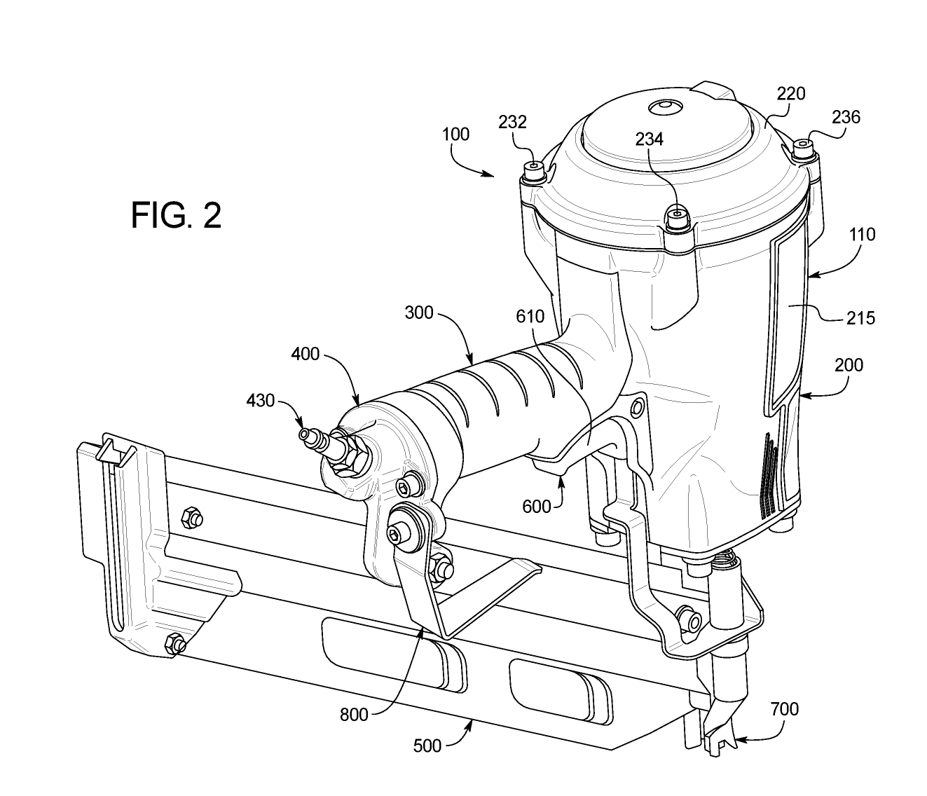

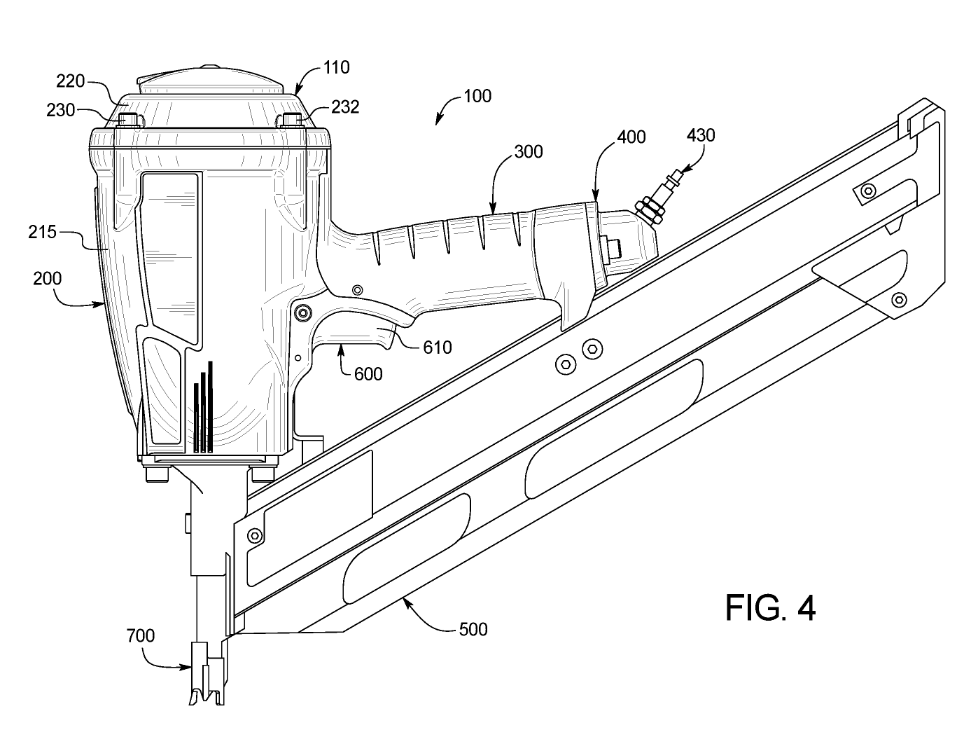

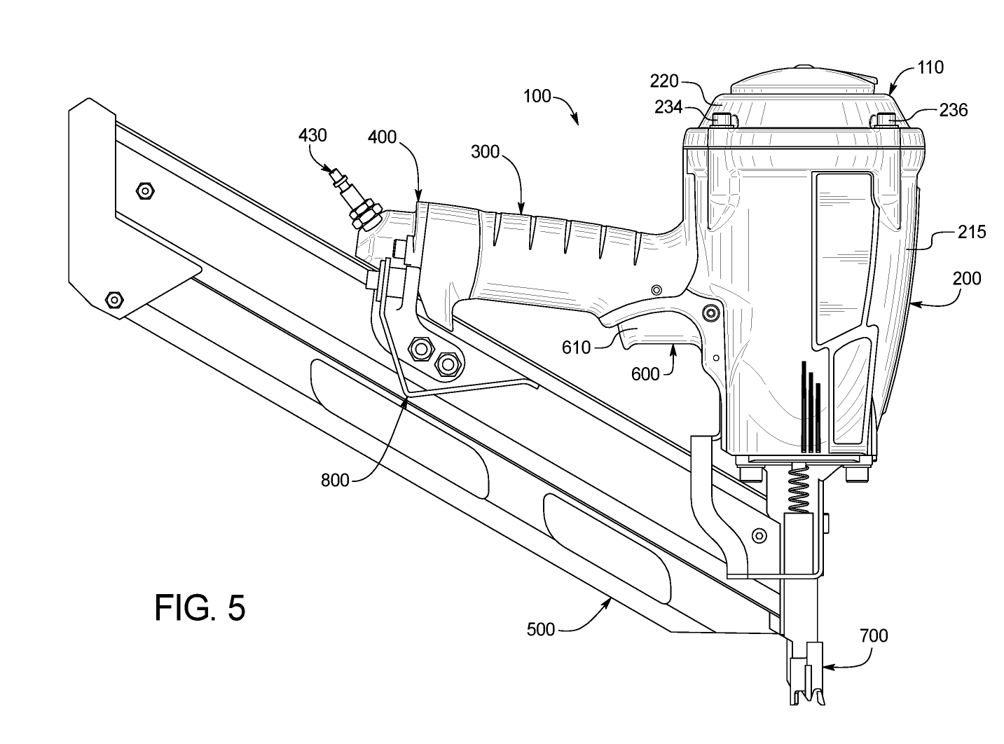

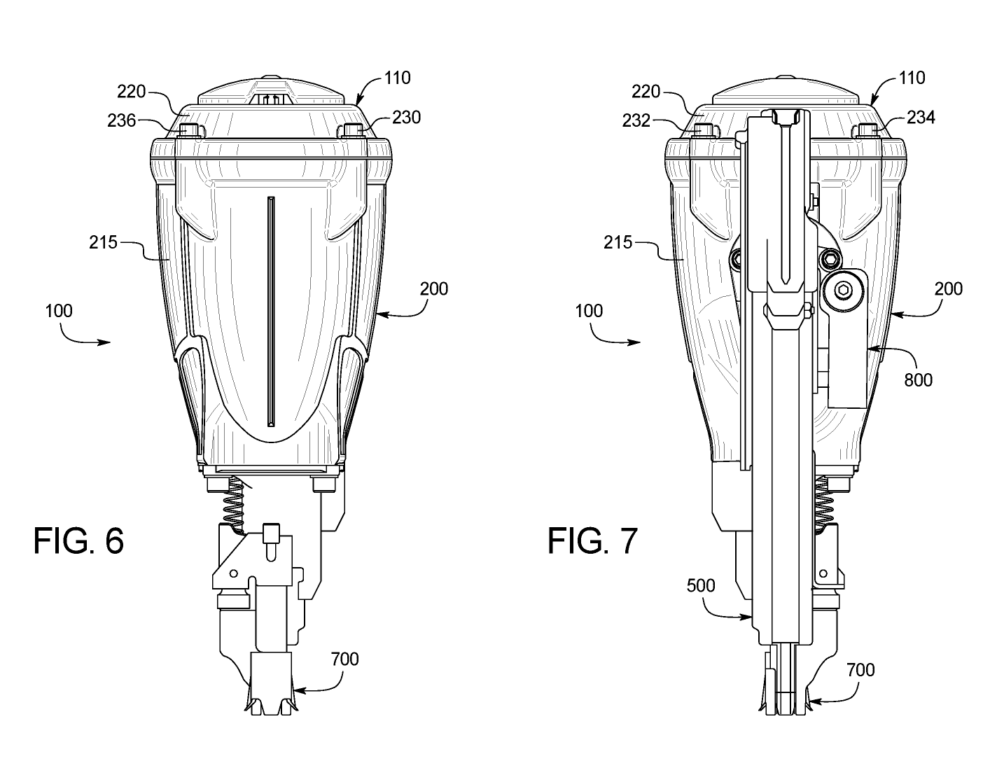

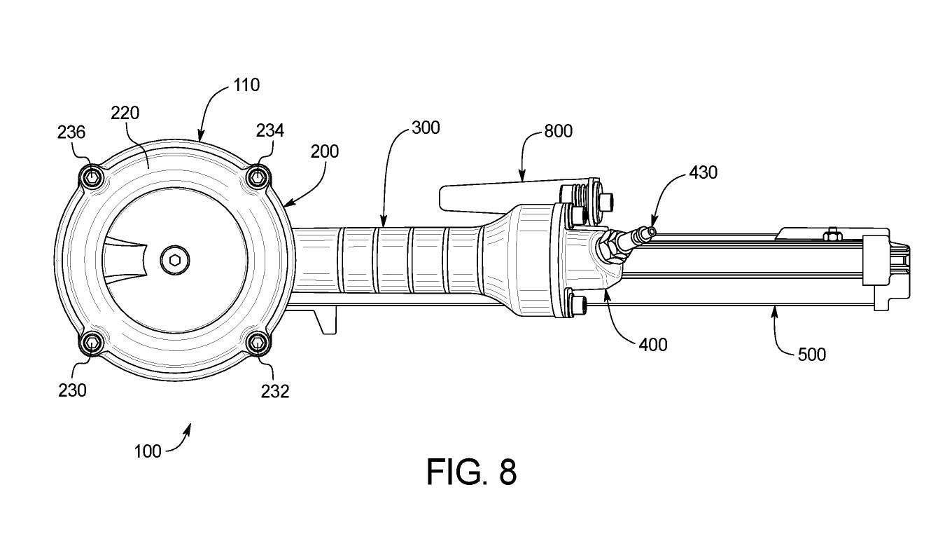

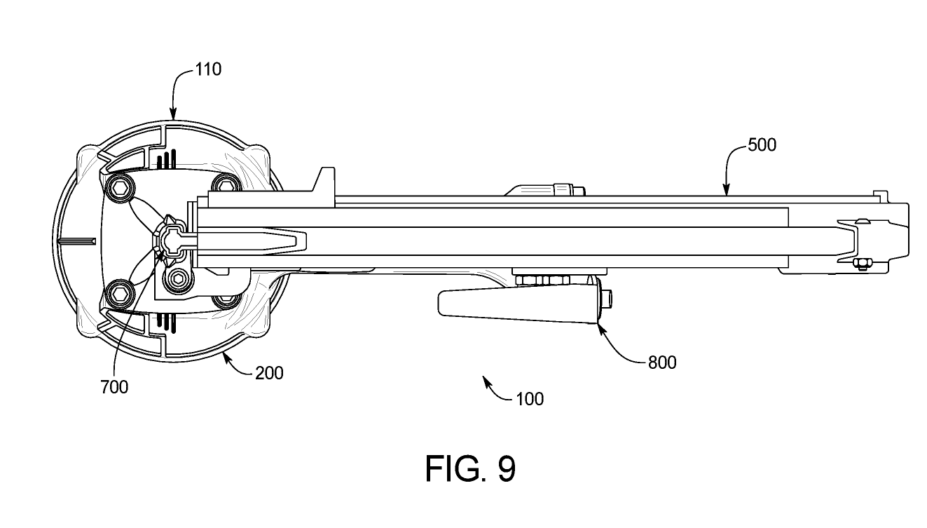

Referring now to the drawings and particularly to FIGS. 2, 3, 4, 5, 6, 7, 8, and 9, the powered fastener driving tool of one example embodiment of the present disclosure is generally illustrated and indicated by numeral 100. The powered fastener driving tool 100 in this illustrated embodiment is a pneumatic nailer. The powered fastener driving tool may be referred to herein as the fastener driving tool, the driving tool, the tool, the pneumatic nailer, the framing nailer, or the nailer for brevity. Such abbreviations are not meant to limit the present disclosure in any manner.

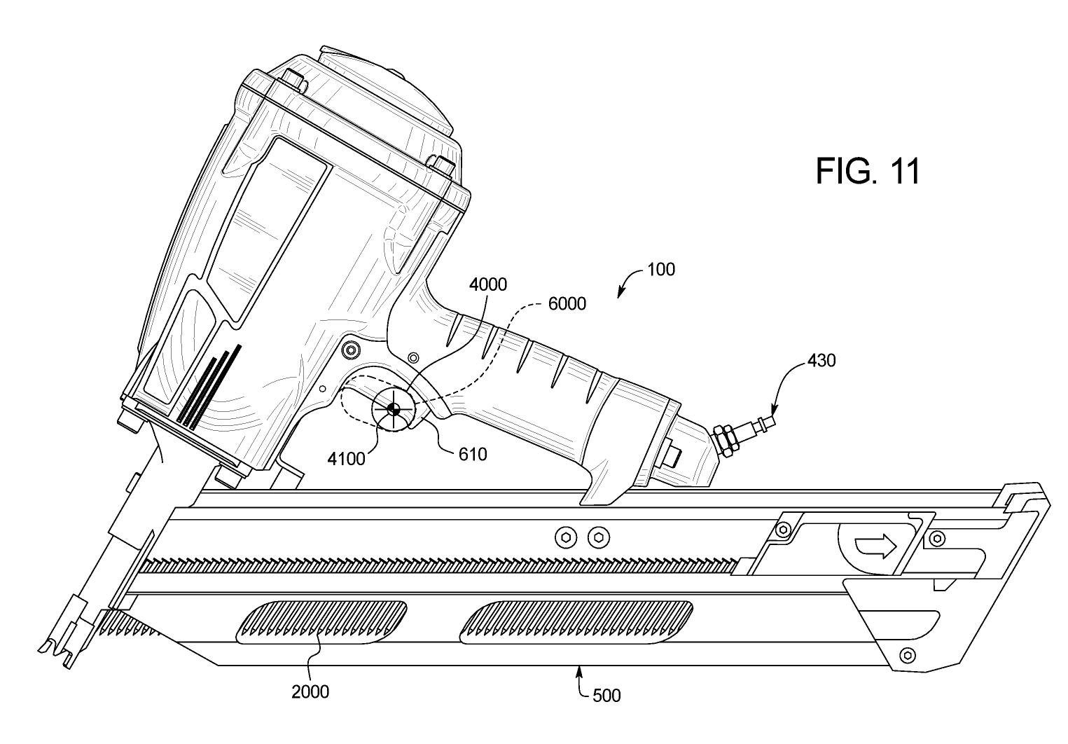

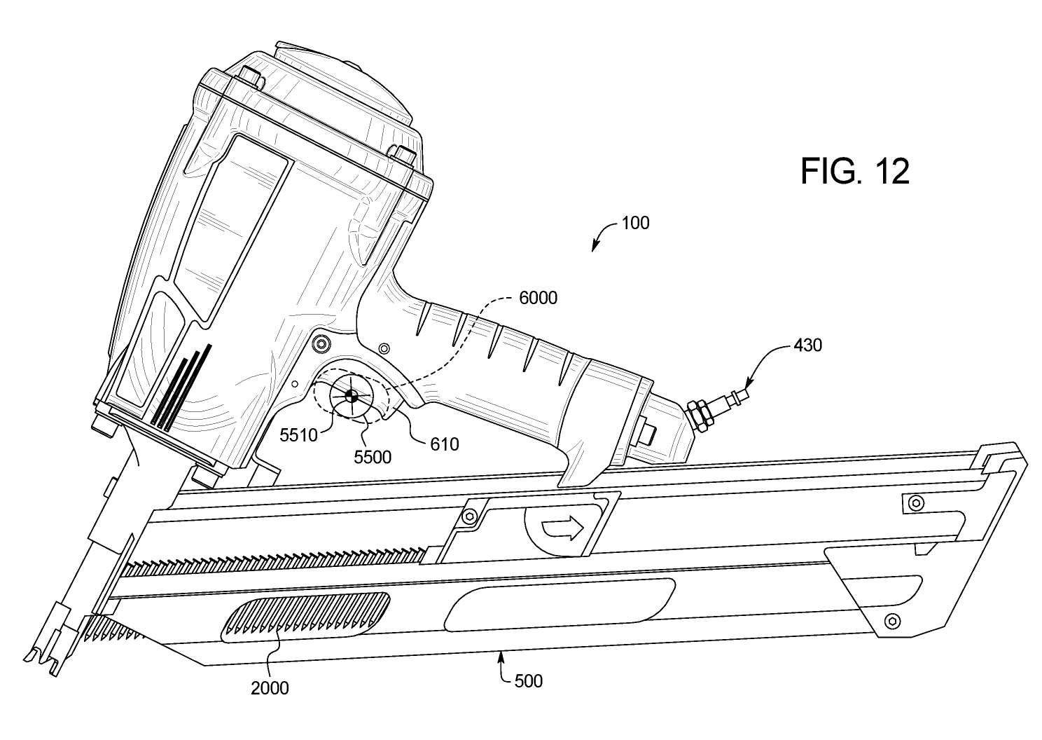

The powered fastener driving tool 100 of this illustrated example embodiment generally includes: (a) a housing assembly 110 including a main compartment assembly 200 and a handle assembly 300 extending from the main compartment assembly 200; (b) an end plug assembly 400 removably attachable to the handle assembly 300; (c) a power source or supply assembly (not shown) positioned in the housing assembly 110; (d) a fastener supply assembly 500 configured to receive fasteners (not shown in FIG. 2, 3, 4, 5, 6, 7, 8, 9, or 10, but shown in FIGS. 11 and 12) and suitably connected to or supported by the housing assembly 110; (e) a fastener driving assembly (not shown) in the main compartment assembly 200 of the housing assembly 110; (f) a trigger mechanism assembly 600 (partially shown) connected to or supported by the handle assembly 300 of the housing assembly 110; (g) a WCE assembly 700 connected to or supported by the main compartment assembly 200 of the housing assembly 110; and (h) a belt hook assembly 800 rotatably connected to the end plug assembly 400.

More specifically, in this illustrated example embodiment, the housing assembly 110 includes an outer shell of the main compartment assembly 200 and an outer shell of the handle assembly 300 integrally formed. The main compartment assembly 200 includes a main housing 215 and an end cap 220 removably attachable to the main housing 210 by a plurality of attachment members such as bolts 230, 232, 234 and 236. The main housing 215 and the end cap 220 define an interior component chamber (not shown). In one embodiment, the main housing and the handle are integrally formed from two metal shells and integrally attached. In another embodiment, the main housing and the handle are separately formed and then integrally attached. In one embodiment, the main housing and the handle are integrally molded.

In this illustrated example embodiment, the end plug assembly 400 is removably attachable to the handle assembly 300 and to the fastener supplier assembly 500. The pneumatic connector 430 extends from the end plug assembly 400.

In this illustrated example embodiment, the power source or supply assembly (not shown) is positioned in the housing assembly 110 and includes one or more channels that extend through the handle assembly 300. This enables the pneumatic connector 430 to communicate pressurized air from the compressed air supply line (not shown in FIG. 2, 3, 4, 5, 6, 7, 8, 9, 10, 11, or 12) to the power source assembly.

In this illustrated example embodiment, the fastener supply assembly 500 is configured to receive fasteners (not shown in FIG. 2, 3, 4, 5, 6, 7, 8, 9, or 10, but shown in FIGS. 11 and 12) and is connected to the fastener driving assembly extending from the housing assembly 110 and to the end plug assembly 400. The fastener supply assembly 500 is configured to receive fasteners and to supply fasteners to the fastener driving assembly.

In this illustrated example embodiment, the fastener driving assembly is partially in the main compartment 200 of the housing assembly 110 and partially extends from the main compartment 200 of the housing assembly 110.

In this illustrated example embodiment, the trigger mechanism assembly 600 is partially in the upper section of the handle assembly 300 of the housing assembly 110 and partially extends therefrom. The trigger mechanism assembly 600 includes a trigger 610 that is supported by and extends from the handle assembly 300 of the housing assembly 110.

In this illustrated example embodiment, the WCE assembly 700 is connected to and extends from the main compartment 200 of the housing assembly 110.

In this illustrated example embodiment, the belt hook assembly 800 is rotatably connected to the end plug 400. This belt hook assembly 800 enables an operator of the tool 100 to use the belt hook when desired and prevents the belt hook from moving to an undesired further upwardly rotated position.

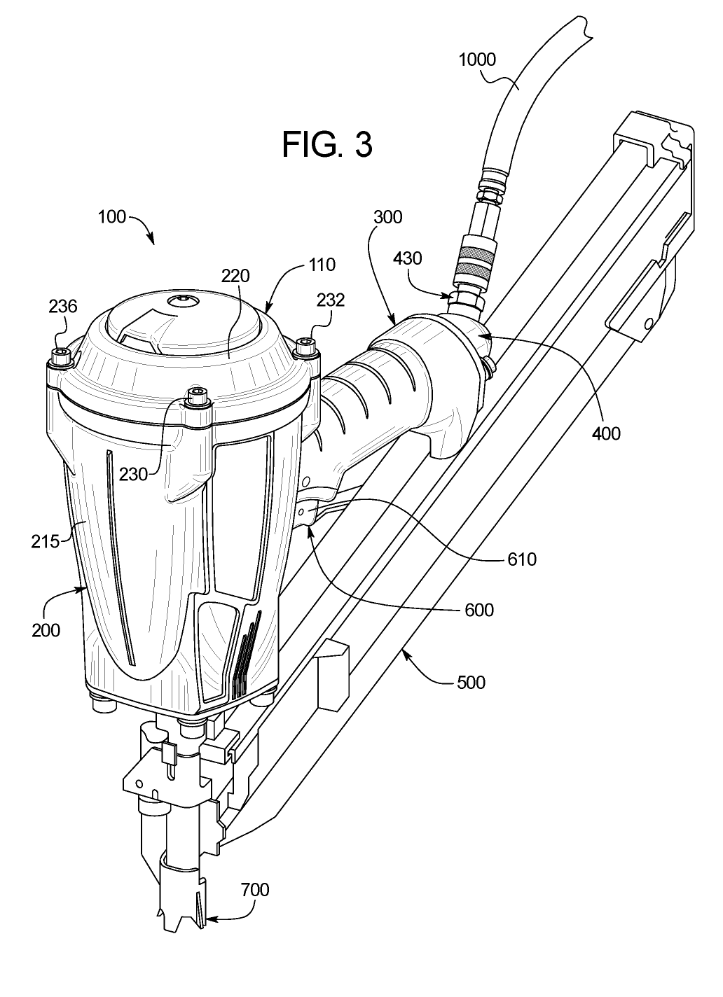

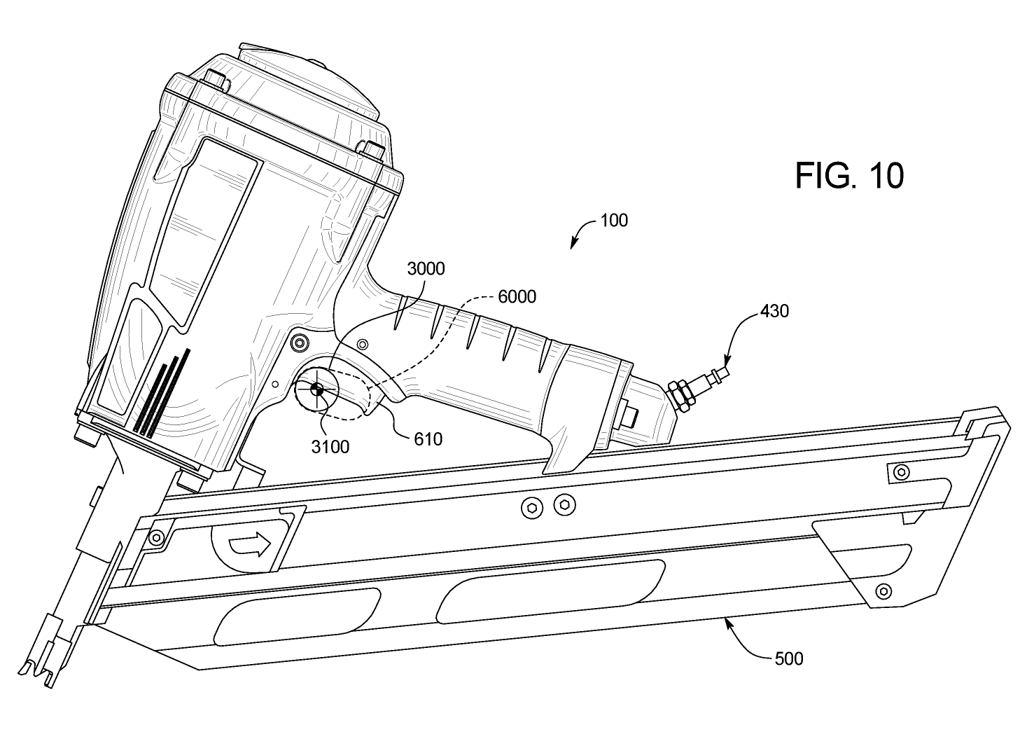

Referring now to FIGS. 10, 11, and 12, various center of gravity envelopes and center of gravity locations in those envelopes for the pneumatic powered fastener driving tool 100 of this example embodiment are shown with respect to the first, the second, and one of the third operational states. As mentioned above: (a) in the first operational state, the fastener supply assembly 500 is completely empty (or does not include any fasteners) and the compressed air supply line (1000 shown in FIG. 3) is not connected to the pneumatic connector 430 as shown in FIG. 10; (b) in the second operational state, the fastener supply assembly 500 includes a full supply of fasteners 2000 and the compressed air supply line is not connected to the pneumatic connector 430 as shown in FIG. 11; and (c) in the third operational states, the fastener supply assembly 500 includes at least one fastener 2000 but less than a full supply of fasteners (i.e., one or more of the fasteners have already been used) and the compressed air supply line is not connected to the pneumatic connector 430. It should be appreciated that FIG. 12 shows one of the many different third operational states in which the fastener supply assembly 500 includes at least one fastener 2000 but less than a full supply of fasteners. The actual quantity of such third operational states will depend on the quantity of fasteners 2000 that fit in the fastener supply assembly 500.

In this illustrated example embodiment: (a) the housing assembly 110 and each component thereof; (b) the end plug assembly 400 and each component thereof; (c) the power source or supply assembly and each component thereof; (d) the fastener supply assembly 500 and each component thereof; (e) a fastener driving assembly and each component thereof; (f) the trigger mechanism assembly 600 and each component thereof; (g) the WCE assembly 700 and each component thereof; (h) the belt hook assembly 800 and each component thereof; and (i) and the pneumatic connector 430 are configured, weighted, sized, shaped, placed, and arranged such that the pneumatic powered fastener driving tool 100 has an optimal total center of gravity envelope which encompasses an area forward and rearward of the top and bottom sections of the trigger 610 of the trigger mechanism assembly 600. This total center of gravity envelope for all of the operational states is referred to herein as the total COG envelope and encompasses the area generally enclosed by the dotted line 6000 in FIGS. 10, 11, and 12.

Additionally, in this illustrated example embodiment: (a) the housing assembly 110 and each component thereof; (b) the end plug assembly 400 and each component thereof; (c) the power source or supply assembly and each component thereof; (d) the fastener supply assembly 500 and each component thereof; (e) a fastener driving assembly and each component thereof; (f) the trigger mechanism assembly 600 and each component thereof; (g) the WCE assembly 700 and each component thereof; (h) the belt hook assembly 800 and each component thereof; and (i) and the pneumatic connector 430 are configured, weighted, sized, shaped, placed, and arranged such that the pneumatic powered fastener driving tool 100 has: (a) the first center of gravity envelope or first COG envelope 3000 shown in FIG. 10 in the first operational state; (b) the second center of gravity envelope or second COG envelope 4000 shown in FIG. 11 in the second operational state; and (c) the third center of gravity envelope or third COG envelope 5500 shown in FIG. 12 in one of the third operational states. In this illustrated example, the pneumatic powered fastener driving tool 100 has: (a) a first center of gravity location 3100 in the first COG envelope 3000 as shown in FIG. 10 for the first operational state; (b) a second center of gravity location 4100 in the second COG envelope as shown in FIG. 11 for the second operational state; and (c) a third center of gravity location 5510 in the third COG envelope 5500 as shown in FIG. 12 for one of the third operational states.

Each envelope 3000, 4000, 5500, and 6000 encompasses the area generally enclosed by its respective two-dimensional dotted line in FIGS. 10, 11, and 12 (e.g., circles). It should be appreciated, however, that such envelopes can encompass three dimensional volumes generally enclosed by three-dimensional shapes, such as spheres, spheroids, or any other suitable shape. For example, in certain embodiments, each envelope encompasses a volume generally enclosed by a sphere centered at a particular point. It should further be appreciated that the shapes of the first, second, and third, envelopes may be the same shape or may be two or more different shapes or may encompass different areas or volumes. It should further be appreciated that the size, shape, and position of each of the first, second, and third COG envelopes can define the total COG envelope.

It should further be appreciated that the exact size of each area or volume encompassed by an envelope will depend on the size of the tool and the components thereof. The size of a particular envelope is, in certain embodiments, determined based on manufacturing tolerances for the tool's components and on tolerances for tool assembly such that the center of gravity locations (for a particular operational state) of all tools manufactured and assembled within those tolerances fall within the envelope. For instance, since the size, mass, and placement of various components may vary from tool to tool, the exact center of gravity location (for a particular operational state) may slightly vary from tool to tool. But while the exact center of gravity locations of different tools may slightly differ (for a particular operational state), the center of gravity location of each tool will nevertheless fall within the center of gravity envelope.

More specifically, in this illustrated embodiment, the tool's center of gravity envelope 3000 indicated in FIG. 10 for the first operational state encompasses an area generally forward and generally rearward of the top section of the trigger 610 and includes a portion of the front face of the trigger 610. Additionally, the first center of gravity location or first COG location 3100 in the envelope 3000 is shown in FIG. 10 for the first operational state and is slightly forward of the front face of the top section of the trigger 610 of the trigger mechanism assembly 600 for this illustrated embodiment.

In this illustrated embodiment, the tool's center of gravity envelope 4000 indicated in FIG. 11 for the second operational state encompasses an area generally forward and generally rearward of the bottom section of the trigger 610 and includes a portion of the front face of the trigger 610. Additionally, the second center of gravity location or second COG location 4100 in the envelope 4000 is shown in FIG. 11 for the second operational state is slightly rearward of the front face of the bottom section of the trigger 610 of the trigger mechanism assembly 600 in this illustrated embodiment.

In this illustrated embodiment, the tool's third center of gravity envelope 5500 moves for each of the third operational states (to represent the states after the tool drives or dispenses each fastener from the fastener supply assembly). Specifically, the tool's center of gravity envelope 5500 repeatedly moves from (or between) the second COG envelope 4000 toward the first COG envelope 3000. One of the third center of gravity locations or third COG locations 5510 is shown in FIG. 12 for one of the third operational states is between the first COG location 3100 and the second COG location 4100 in this illustrated embodiment, and encompasses an area generally forward and generally rearward of the trigger 610 and includes a portion of the front face of the trigger 610.

For this illustrated embodiment: (a) a standard 0.25 NPT×0.25 Industrial Type Air Coupling (MIL-C4109); and (b) 3.25×0.131 nails were employed to confirm the positions of the center of gravity envelopes and locations. For this illustrated embodiment, a table top height of 2.5 feet was employed to confirm the locations of the center of gravity envelopes and locations. Thus, the tests performed were under suitable controlled conditions.

It should be appreciated that as the tool moves from one third operational state to another, the third envelope of the tool's center of gravity continuously changes to a slight degree after the tool drives or dispenses each fastener in the fastener supplier assembly 500. It should thus also be appreciated that each of the plurality of third center of gravity envelopes for each of the respective third operational states is at least partially between the first center of gravity envelope and the second center of gravity envelope in various embodiments of the present disclosure.

It should be appreciated from this illustrated example embodiment, that in various embodiments, the pneumatic powered fastener driving tool has various components configured, weighted, sized, shaped, placed, and arranged such that a first center of gravity envelope that encompasses a first defined area related to a top section of a trigger of the tool for a first operational state, a second center of gravity envelope that encompasses a second defined area related to a bottom section of the trigger of the tool for a second operational state, and a plurality of third center of gravity envelopes that each encompass an area between the first center of gravity envelope and the second center of gravity envelope for third operational states.

It should further be appreciated from this illustrated example embodiment, that in certain embodiments, the centers of each of the first center of gravity envelope (for the first operational state), the second center of gravity envelope (for the second operational state), and the plurality of third center of gravity envelopes (for the third operational states) generally form a line that extends or is aligned generally along the front face of the trigger of the tool, and in certain such embodiments is parallel or substantially parallel to the front face of the trigger of the tool. In these embodiments, the total or combined center of gravity envelope extends along and encompasses at least part of the front face of the trigger of the tool. In other such embodiments in which the total or combined center of gravity envelope extends along and encompasses at least part of the front face of the trigger of the tool, the centers of each of the first center of gravity envelope, the second center of gravity envelope, and the plurality of third center of gravity envelopes generally form a line that is substantially parallel to but offset forward or rearward from the front face of the trigger of the tool.

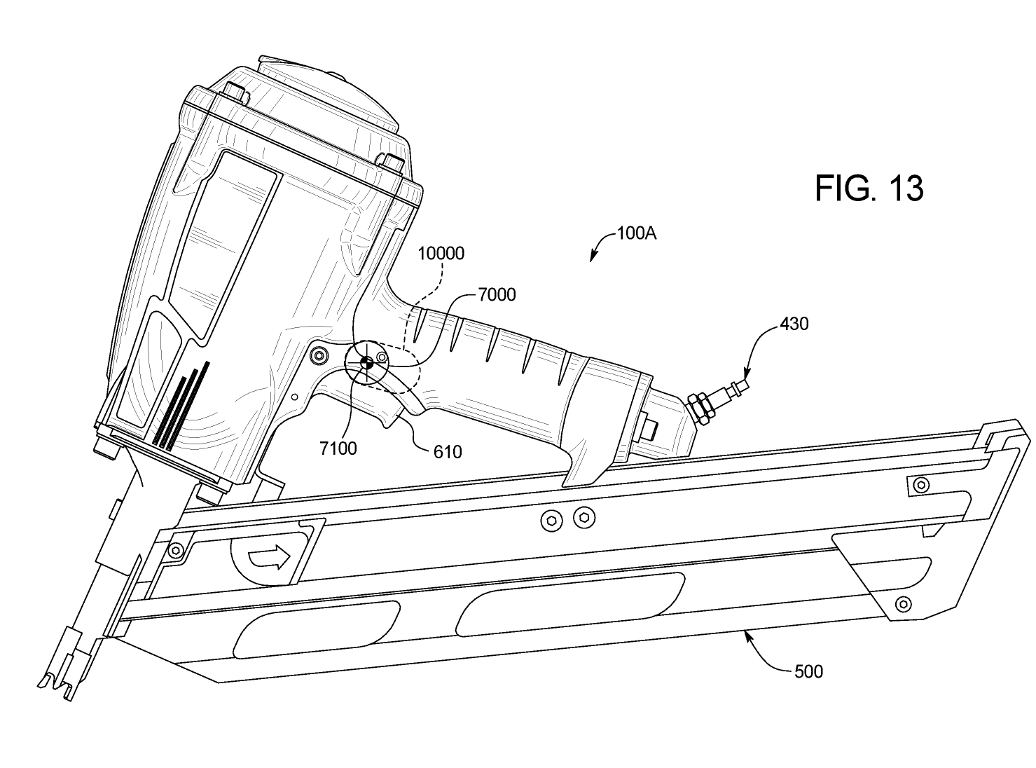

It should further be appreciated that in certain other embodiments, the centers of each of the first center of gravity envelope (for the first operational state), the second center of gravity envelope (for the second operational state), and the plurality of third center of gravity envelopes (for the third operational states) generally form a line that extends or is aligned generally rearward of the front face of the trigger of the tool (or in some embodiments the trigger of the tool), and in certain such embodiments extends parallel or substantially parallel to—but offset rearwardly from—the front face of the trigger of the tool. An example of this is discussed below with respect to FIGS. 13, 14, and 15. In these embodiments, the total or combined center of gravity envelope extends substantially parallel to the front face of the trigger of the tool but is offset rearwardly from and does not encompass the front face of the trigger of the tool.

It should further be appreciated that in certain other embodiments, the centers of each of the first center of gravity envelope (for the first operational state), the second center of gravity envelope (for the second operational state), and the plurality of third center of gravity envelopes (for the third operational states) generally form a line that extends or is aligned generally forward of the front face of the trigger of the tool, and in certain such embodiments extends parallel or substantially parallel to—but offset forward from—the front face of the trigger of the tool. In these embodiments, the total or combined center of gravity envelope extends substantially parallel to the front face of the trigger of the tool but is offset rearwardly from and does not encompass the front face of the trigger of the tool.

It should further be appreciated that the components of the pneumatic powered fastener driving tool 100 are configured, weighted, sized, shaped, placed, and arranged such that the tool 100 has the first, second, and third COG locations in the respective envelopes when respectively in the first, second, and third operational states. It should also be appreciated that the components of the pneumatic powered fastener driving tool can be configured, weighted, sized, shaped, placed, and arranged in numerous different manners to achieve the first, second, and third COG locations in the respective envelopes when respectively in the first, second, and third operational states.

It should be appreciated that each of the first, second, and third center of gravity envelopes are centered along a defined plane such as a central plane between the two sides or two symmetric sides of the main compartment 215 of the housing 110 or the trigger 610. In various embodiments, the location of the tool's center of gravity relative to the tool's width or sides does not substantially vary as fasteners are driven.

It should be appreciated that the pneumatic powered fastener driving tool 100 has center of gravity envelopes and locations in those respective envelopes that are positioned or located relative to one another along optimal directions and within optimal distances and relative to the trigger 610 based on such operational states.

It should also be appreciated that the pneumatic powered fastener driving tool 100 having each of these first, second, and third center of gravity envelopes and locations in those envelopes individually reduces the fatigue on the operators by providing a more balanced tool in each of the different respective operation states.

It should also be appreciated that the pneumatic powered fastener driving tool 100 providing a plurality but less than all of the first, second, and third center of gravity envelopes and locations in those respective envelopes reduces the fatigue on the operators by providing a more overall balanced tool for a combination of each of the respective different operational states.

It should further be appreciated that the pneumatic powered fastener driving tool 100 providing the combination of all of the first, second, and third center of gravity envelopes and locations in those respective envelopes reduces the fatigue on the operators by providing a more overall balanced tool for a combination of each of the respective different operational states.

It should further be appreciated that in other embodiments of the present disclosure, the pneumatic powered fastener driving tool includes one, two, or a plurality but not all of the first, second, and third COG envelopes and locations in those respective envelopes.

It should further be appreciated that the third COG envelopes form a combined third COG envelope that at least partially extends between the first COG envelope and the second envelope.

It should further be appreciated that the third COG envelopes form a combined third COG envelope that can at least partially overlap one or both of the first COG envelope and the second envelope.

It should further be appreciated that in various embodiments, the first, second, and third COG envelopes form a combined or total COG envelope for the entire fastener driving tool such that the center of gravity locations for each of the operational states is in this combined envelope.

It should further be appreciated that in various embodiments, two or more of the first and second COG envelopes at least partially overlap.

It should further be appreciated that in various embodiments, the first and second COG envelopes do not overlap.

It should be appreciated that in various embodiments, the powered fastener driving tool is made as stated above without belt hook assembly connected to the end plug assembly.

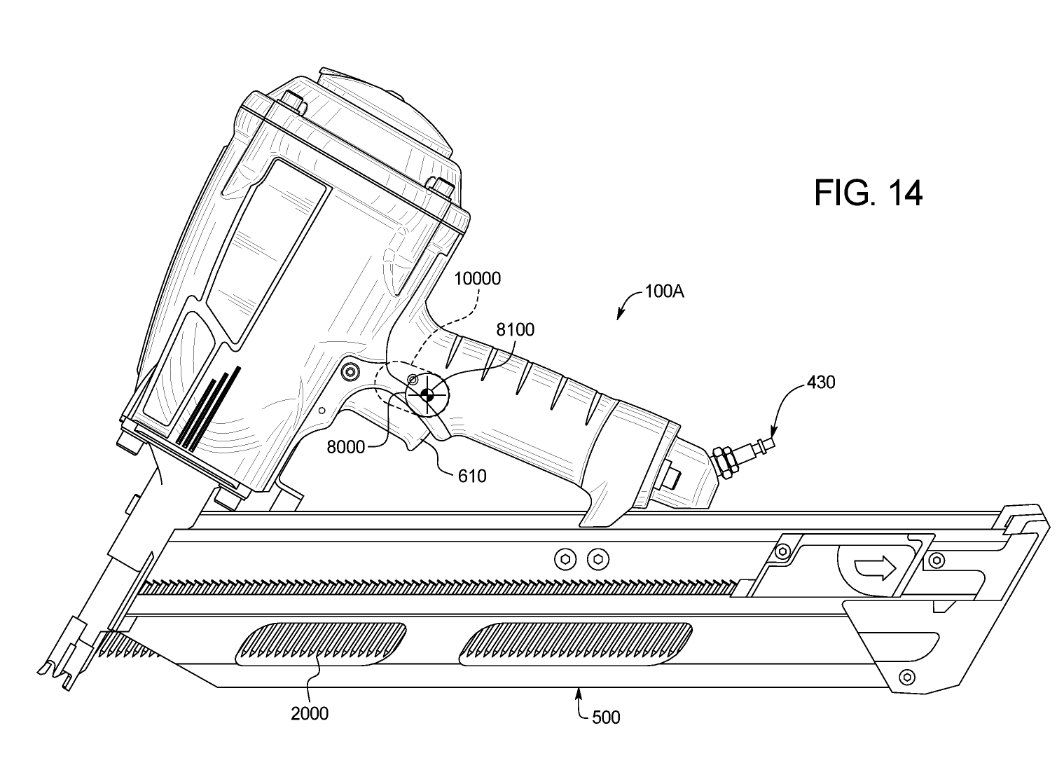

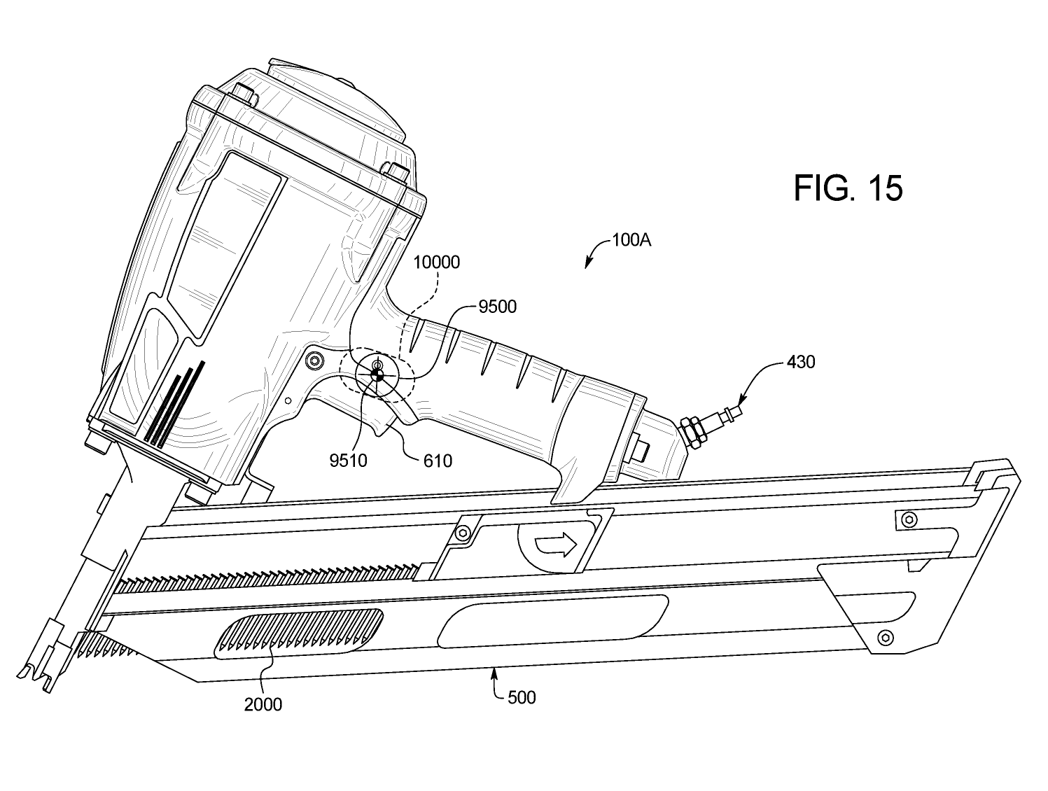

As mentioned above, the total or combined center of gravity envelopes may be in alternative locations in accordance with the present disclosure. Turing now to FIGS. 13, 14, and 15, one example of an alternative embodiment of the present disclosure is illustrated. In this illustrated example embodiment, the combination of components are configured, weighted, sized, shaped, placed, and arranged such that the pneumatic powered fastener driving tool 100A has: (a) the first center of gravity envelope or first COG envelope 7000 shown in FIG. 13 in the first operational state; (b) the second center of gravity envelope or second COG envelope 8000 shown in FIG. 14 in the second operational state; and (c) the third center of gravity envelope or third COG envelope 9500 shown in FIG. 15 in one of the third operational states. In this illustrated example, the pneumatic powered fastener driving tool 100A has: (a) a first center of gravity location 7100 in the first COG envelope 6000 as shown in FIG. 13 for the first operational state; (b) a second center of gravity location 8100 in the second COG envelope 8000 as shown in FIG. 14 for the second operational state; and (c) a third center of gravity location 9510 in the third COG envelope 9500 as shown in FIG. 15 for one of the third operational states.

It should be appreciated that each of the envelopes 7000, 8000, and 9000 encompass areas defined by two dimensional circles in FIGS. 13, 14, and 15, but that such envelopes can encompass three dimensional volumes as described above.

More specifically, in this illustrated embodiment, the tool's center of gravity envelope 7000 indicated in FIG. 13 for the first operational state encompasses an area rearward of the front face of the top section of the trigger of the trigger mechanism assembly. Additionally, the first center of gravity location or first COG location 7100 in the envelope 7000 is shown in FIG. 13 for the first operational state and is rearward of the top section of the trigger 610 of the trigger mechanism assembly 600 for this illustrated embodiment.

In this illustrated embodiment, the tool's center of gravity envelope 8000 indicated in FIG. 14 for the second operational state encompasses an area rearward of the front face of the bottom section of the trigger of the trigger mechanism assembly. Additionally, the second center of gravity location or second COG location 8100 in the envelope 8000 is shown in FIG. 14 for the second operational state is rearward of the bottom section of the trigger 610 of the trigger mechanism assembly 600 in this illustrated embodiment.

In this illustrated embodiment, the tool's third center of gravity envelope 9500 moves for each of the third operational states (to represent the states when the tool drives or dispenses each fastener from the fastener supply assembly). Specifically, the tool's center of gravity envelope 8500 repeatedly moves from (or between) the second COG envelope 8000 toward the first COG envelope 7000. One of the third center of gravity locations or third COG locations 9510 is shown in FIG. 15 for one of the third operational states is between the first COG location 100 and the second COG location 7100 in this illustrated embodiment.

It should be appreciated from this example embodiment that the first center of gravity envelope, the second center of gravity envelope, and the plurality of third center of gravity envelopes, as well as the first center of gravity location, the second center of gravity location, and plurality of third center of gravity locations can be rearward of the trigger of the tool, and in certain such embodiments extend parallel or substantially parallel to the trigger of the tool.

It will be understood that modifications and variations may be effected without departing from the scope of the novel concepts of the present invention, and it is understood that this application is to be limited only by the scope of the claims.

The invention is claimed as follows:

1. A powered fastener driving tool comprising:
(a) a housing assembly including a main compartment and a handle assembly extending from the main compartment;
(b) an end plug assembly removably attached to the handle assembly;
(c) a power source or supply assembly positioned in the housing assembly;
(d) a fastener supply assembly configured to receive fasteners and connected to the housing assembly;
(e) a fastener driving assembly supported by the housing assembly;
(f) a trigger mechanism assembly connected to the handle assembly of the housing assembly and including a trigger having a front face;
(g) a work piece contact element assembly connected to the main compartment of the housing assembly; and
(h) a pneumatic connector connected to the end plug assembly, the powered fastener driving tool having:
(i) a first operational state in which the fastener supply assembly does not include any fasteners and no compressed air supply line is connected to the pneumatic connector;
(ii) a second operational state in which the fastener supply assembly includes a full supply of fasteners and no compressed air supply line is connected to the pneumatic connector; and
(iii) third operational states in which the fastener supply assembly includes at least one and less than a full supply of fasteners and no compressed air supply line is connected to the pneumatic connector;
wherein the housing assembly, the end plug assembly, the power source or supply assembly, the fastener supply assembly, the fastener driving assembly, the trigger mechanism assembly, and the work piece contact element assembly are configured, weighted, sized, shaped, placed, and arranged such that:
a first center of gravity envelope for the first operational state encompasses an area forward and rearward of the front face of a top section of the trigger of the trigger mechanism assembly;
a second center of gravity envelope for the second operational state encompasses an area forward and rearward of the front face of a bottom section of the trigger of the trigger mechanism assembly; and
one of a plurality of third center of gravity envelopes for one of the third operational states encompasses an area between the first center of gravity envelope and the second center of gravity envelope.

2. The powered fastener driving tool of claim 1, which is a pneumatic nailer.

3. The powered fastener driving tool of claim 1, which has a first center of gravity location in the first center of gravity envelope for the first operational state.

4. The powered fastener driving tool of claim 1, which has a second center of gravity location in the second center of gravity envelope for the second operational state.

5. The powered fastener driving tool of claim 1, which has one of a plurality of third center of gravity locations in one of the third center of gravity envelopes for one of the third operational states.

6. The powered fastener driving tool of claim 1, which has a plurality of third center of gravity locations in the respective third center of gravity envelopes for the respective third operational states.

7. The powered fastener driving tool of claim 1, which has: a first center of gravity location in the first center of gravity envelope for the first operational state; a second center of gravity location in the second center of gravity envelope for the second operational state; and one of a plurality of third center of gravity locations in one of the third center of gravity envelopes for one of the third operational states.

8. The powered fastener driving tool of claim 1, which has: a first center of gravity location in the first center of gravity envelope for the first operational state; a second center of gravity location in the second center of gravity envelope for the second operational state; and a plurality of third center of gravity locations in the respective third center of gravity envelopes for the respective third operational states.

9. The powered fastener driving tool of claim 1, which has a belt hook assembly rotatably connected to the end plug assembly.

10. The powered fastener driving tool of claim 1, wherein the first center of gravity envelope, the second center of gravity envelope, and the plurality of third center of gravity envelopes collectively form a total center of gravity envelope extending parallel or substantially parallel to the front face of the trigger.

11. A powered fastener driving tool comprising:
(a) a housing assembly including a main compartment and a handle assembly extending from the main compartment;
(b) an end plug assembly removably attached to the handle assembly;
(c) a power source or supply assembly positioned in the housing assembly;
(d) a fastener supply assembly configured to receive fasteners and connected to the housing assembly;
(e) a fastener driving assembly supported by the housing assembly;
(f) a trigger mechanism assembly connected to the handle assembly of the housing assembly and including a trigger having a front face;
(g) a work piece contact element assembly connected to the main compartment of the housing assembly; and
(h) a pneumatic connector connected to the end plug assembly, the powered fastener driving tool having:
(i) a first operational state in which the fastener supply assembly does not include any fasteners and no compressed air supply line is connected to the pneumatic connector;
(ii) a second operational state in which the fastener supply assembly includes a full supply of fasteners and no compressed air supply line is connected to the pneumatic connector; and
(iii) third operational states in which the fastener supply assembly includes at least one and less than a full supply of fasteners and no compressed air supply line is connected to the pneumatic connector;
wherein the housing assembly, the end plug assembly, the power source or supply assembly, the fastener supply assembly, the fastener driving assembly, the trigger mechanism assembly, and the work piece contact element assembly are configured, weighted, sized, shaped, placed, and arranged such that:
the powered fastener driving tool has a first center of gravity location forward of the front face of a top section of the trigger of the trigger mechanism assembly for the first operational state;
the powered fastener driving tool has a second center of gravity location rearward of the front face of a bottom section of the trigger of the trigger mechanism assembly for the second operational state; and
the powered fastener driving tool has one of a plurality of third center of gravity locations between the first center of gravity location and the second center of gravity location for one of the third operational states.

12. The powered fastener driving tool of claim 11, which is a pneumatic nailer.

13. The powered fastener driving tool of claim 11, which includes a belt hook assembly rotatably connected to the end plug assembly.

14. The powered fastener driving tool of claim 11, wherein the first center of gravity location, the second center of gravity location, and the plurality of third center of gravity locations generally define a line extending parallel or substantially parallel to the front face of the trigger.

15. A powered fastener driving tool comprising:
(a) a housing assembly including a main compartment and a handle assembly extending from the main compartment;
(b) an end plug assembly removably attached to the handle assembly;
(c) a power source or supply assembly positioned in the housing assembly;
(d) a fastener supply assembly configured to receive fasteners and connected to the housing assembly;
(e) a fastener driving assembly supported by the housing assembly;
(f) a trigger mechanism assembly connected to the handle assembly of the housing assembly and including a trigger having a front face; and
(g) a work piece contact element assembly connected to the main compartment of the housing assembly; and
(h) a pneumatic connector connected to the end plug assembly, the powered fastener driving tool having:
(i) a first operational state in which the fastener supply assembly does not include any fasteners and no compressed air supply line is connected to the pneumatic connector;
(ii) a second operational state in which the fastener supply assembly includes a full supply of fasteners and no compressed air supply line is connected to the pneumatic connector; and
(iii) third operational states in which the fastener supply assembly includes at least one and less than a full supply of fasteners and no compressed air supply line is connected to the pneumatic connector;
wherein the housing assembly, the end plug assembly, the power source or supply assembly, the fastener supply assembly, the fastener driving assembly, the trigger mechanism assembly, and the work piece contact element assembly are configured, weighted, sized, shaped, placed, and arranged such that:
a first center of gravity envelope for the first operational state encompasses a first defined area related to a top section of the trigger of the trigger mechanism assembly;
a second center of gravity envelope for the second operational state encompasses a second defined area related to a bottom section of the trigger of the trigger mechanism assembly; and
one of a plurality of third center of gravity envelopes for one of the third operational states encompass an area between the first center of gravity envelope and the second center of gravity envelope, wherein the first center of gravity envelope, the second center of gravity envelope, and the plurality of third center of gravity envelopes collectively form a total center of gravity envelope extending parallel or substantially parallel to the trigger.

16. The powered fastener driving tool of claim 15, which is a pneumatic nailer.

17. The powered fastener driving tool of claim 15, which has a belt hook assembly rotatably connected to the end plug assembly.

18. The powered fastener driving tool of claim 15, where the first defined area for the first center of gravity envelope is forward and rearward of the front face of the top section of the trigger of the trigger mechanism assembly, where the second defined area for the second center of gravity envelope is forward of and rearward of the front face of the bottom section of the trigger of the trigger mechanism assembly, and where the defined area for one of the third center of gravity envelopes is forward of and rearward of the front face of the trigger of the trigger mechanism assembly.

19. The powered fastener driving tool of claim 15, where the first defined area for the first center of gravity envelope is rearward of the front face of the top section of the trigger of the trigger mechanism assembly, where the second defined area for the second center of gravity envelope is rearward of the front face of the bottom section of the trigger of the trigger mechanism assembly, and where the defined area for one of the third center of gravity envelopes is rearward of the front face of the trigger of the trigger mechanism assembly.

20. The powered fastener driving tool of claim 15, where the first defined area for the first center of gravity envelope is forward of the front face of the top section of the trigger of the trigger mechanism assembly, where the second defined area for the second center of gravity envelope is forward of the front face of the bottom section of the trigger of the trigger mechanism assembly, and where the defined area for one of the third center of gravity envelopes is forward of the front face of the trigger of the trigger mechanism assembly.

21. A powered fastener driving tool comprising:
(a) a housing assembly including a main compartment and a handle assembly extending from the main compartment;
(b) an end plug assembly removably attached to the handle assembly;
(c) a power source or supply assembly positioned in the housing assembly;
(d) a fastener supply assembly configured to receive fasteners and connected to the housing assembly;
(e) a fastener driving assembly supported by the housing assembly;
(f) a trigger mechanism assembly connected to the handle assembly of the housing assembly and including a trigger having a front face;
(g) a work piece contact element assembly connected to the main compartment of the housing assembly; and
(h) a pneumatic connector connected to the end plug assembly, the powered fastener driving tool having:
(i) a first operational state in which the fastener supply assembly does not include any fasteners and no compressed air supply line is connected to the pneumatic connector;
(ii) a second operational state in which the fastener supply assembly includes a full supply of fasteners and no compressed air supply line is connected to the pneumatic connector; and
(iii) third operational states in which the fastener supply assembly includes at least one and less than a full supply of fasteners and no compressed air supply line is connected to the pneumatic connector;
wherein the housing assembly, the end plug assembly, the power source or supply assembly, the fastener supply assembly, the fastener driving assembly, the trigger mechanism assembly, and the work piece contact element assembly are configured, weighted, sized, shaped, placed, and arranged such to have a total center of gravity envelope which encompasses an area which includes the following:
a first center of gravity location forward of the front face of a top section of the trigger of the trigger mechanism assembly for the first operational state;
a second center of gravity location rearward of the front face of a bottom section of the trigger of the trigger mechanism assembly for the second operational state; and
a plurality of third center of gravity locations between the first center of gravity location and the second center of gravity location for a plurality of the third operational states.

22. The powered fastener driving tool of claim 21, which is a pneumatic nailer.

23. The powered fastener driving tool of claim 21, which includes a belt hook assembly rotatably connected to the end plug assembly.

24. The powered fastener driving tool of claim 21, wherein the first center of gravity location, the second center of gravity location, and the plurality of third center of gravity locations generally form a line extending parallel or substantially parallel to the front face of the trigger.

25. A powered fastener driving tool comprising:
(a) a housing assembly including a main compartment and a handle assembly extending from the main compartment;
(b) an end plug assembly removably attached to the handle assembly;
(c) a power source or supply assembly positioned in the housing assembly;
(d) a fastener supply assembly configured to receive fasteners and connected to the housing assembly;
(e) a fastener driving assembly supported by the housing assembly;
(f) a trigger mechanism assembly connected to the handle assembly of the housing assembly and including a trigger having a front face;
(g) a work piece contact element assembly connected to the main compartment of the housing assembly; and
(h) a pneumatic connector connected to the end plug assembly, the powered fastener driving tool having:
(i) a first operational state in which the fastener supply assembly does not include any fasteners and no compressed air supply line is connected to the pneumatic connector;
(ii) a second operational state in which the fastener supply assembly includes a full supply of fasteners and no compressed air supply line is connected to the pneumatic connector; and
(iii) third operational states in which the fastener supply assembly includes at least one and less than a full supply of fasteners and no compressed air supply line is connected to the pneumatic connector;
wherein the housing assembly, the end plug assembly, the power source or supply assembly, the fastener supply assembly, the fastener driving assembly, the trigger mechanism assembly, and the work piece contact element assembly are configured, weighted, sized, shaped, placed, and arranged such to have a first center of gravity location forward of the front face of a top section of the trigger of the trigger mechanism assembly for the first operational state.

26. The powered fastener driving tool of claim 25, which is a pneumatic nailer.

27. The powered fastener driving tool of claim 25, which includes a belt hook assembly rotatably connected to the end plug assembly.
